(19) United States
(12) Patent Application Publication
(10) Pub. No.: US 2021/0354584 A1
(43) Pub. Date: Nov. 18, 2021

(54) METHOD AND SYSTEM FOR QUANTITATIVE ENERGY VERIFICATION OF AN ELECTRIC CHARGING PROCESS AND SERVER DEVICE FOR THE SYSTEM

(71) Applicant: AUDI AG, Ingolstadt (DE)

(72) Inventor: Marcel DIETZ, Ingolstadt (DE)

(21) Appl. No.: 17/322,696

(22) Filed: May 17, 2021

(30) Foreign Application Priority Data
May 18, 2020 (DE) 102020113342.1

(51) Int. Cl. B60L 53/66

(52) U.S. Cl. CPC B60L 53/66

(57) ABSTRACT

A method for the verification of an electric charging process is provided, wherein electric energy is transferred by the charging process between an electrically operated motor vehicle and an electric charging station and station-side measurement data about the charging process are generated by a metering circuit of the charging station and the station-side measurement data are received by a server device from the charging station. Vehicle-side charging data about the same charging process are generated by a control circuit of the motor vehicle and the vehicle-side charging data are received by the server device from the motor vehicle and the server device operates a predetermined consensus algorithm in order to generate on the basis of the measurement data and the charging data a consensus value consistently describing the charging process for both the charging station and for the motor vehicle.

### BACKGROUND

### Technical Field

Embodiments of the invention relate to a method for the verification of an electric charging process, by which electric energy is transferred between an electrically operated motor vehicle and an electric charging station. Furthermore, the quality of use of the motor vehicle as well as that of the electric charging station can be evaluated. Embodiments of the invention also relate to a system by which the method can be carried out, as well as a server device which can be used as a component of the system.

### Description of the Related Art

In a system having electric charging stations and motor vehicles being supplied by them, the precise verified kWh (kilowatt-hour) energy quantity of transferred energy is an important basis for a correct monetary settlement in the charging process. A verified determination of the energy quantity oftentimes can only be provided by a calibrated meter in the particular charging station. But this leads to the drawback that a system for such a charging infrastructure is cost intensive.

It is known from WO 2020/009 666 A1 that a payment after a charging process can be done by means of a crypto currency. Furthermore, it is described that a motor vehicle can itself measure how much energy it has received from the charging station. However, the charging station and the motor vehicle measure the energy quantity at different metering points, so that a discrepancy may occur in the measured values. It is not clear here how to deal with that situation.

It is known from DE 10 2018 112 118 A1 that a blockchain can be used to make data available to multiple users, without having to separately verify the authenticity of the data, because the blockchain itself assures the authenticity.

It is known from WO 2019/057 330 A1 that a controller of a motor vehicle can also be used as a node of a computing network external to the vehicle during a charging process.

### BRIEF SUMMARY

Embodiments described herein provide an economical or inexpensive charging infrastructure for supplying motor vehicles with electric energy.

Embodiments described herein provide a method for the verification of an electric charging process, wherein electric energy is transferred by the charging process between an electrically operated motor vehicle and an electric charging station and station-side measurement data about the charging process are generated by a metering circuit of the charging station and the station-side measurement data are received by a server device from the charging station. This corresponds to the station-side metering of the transferred energy quantity, i.e., the delivered energy quantity, for example. But the metering may also involve an energy quantity taken up by the charging station, such as can be provided in a so-called feedback, when a motor vehicle returns electric energy from its electric energy storage via the charging station to an electric power grid or current grid. Thus, the term “charging process” can mean both a charging and a discharging of the electric energy storage of the motor vehicle.

The method is characterized in that vehicle-side charging data about the same charging process are additionally generated by a control circuit of the motor vehicle and the vehicle-side charging data are received by the server device from the motor vehicle and the server device operates a predetermined consensus algorithm in order to generate on the basis of the measurement data and the charging data a consensus value consistently describing the charging process for both the charging station and for the motor vehicle. In other words, therefore, the transferred energy quantity is detected or measured by both the charging station and the motor vehicle, i.e., in particular, with two different metering circuits, namely, a station-side and a vehicle-side circuit.

Moreover, if the consensus algorithm reports a successful determination of the consensus value (i.e., if a consensus value can be found), the server device then initiates and/or continues a predetermined continuation procedure to continue the charging process and/or to further process the consensus value. Otherwise (i.e., if the consensus algorithm reports an unsuccessful determination of the consensus value), the server device initiates a predetermined termination procedure to terminate the charging process. In other words, the motor vehicle and the charging station can be used as measurement objects which mutually monitor each other, since the measurement objects act as the power source and power sink for the same transferred energy, because their metering circuits had to generate the same measurement values. This is verified by the independent server device and measurement deviations are handled or balanced out by the consensus algorithm. The consensus value can represent a description of the transferred energy quantity which is binding on all participating parties. Therefore, metering circuits without calibration can be used, since neither of the measurement objects (motor vehicle or charging station) has to rely on the measurement data of the other, but instead can furnish its own measurement data to the consensus algorithm.

The charging station utilized here can be in particular a charging column, such as can be set up on a roadside or at a parking place. The metering circuit of the charging station may comprise, in particular, an energy meter at a charging terminal of the charging station. The measurement data may describe in particular the energy quantity and/or an electric quantity (such as voltage and/or current strength) and/or a power. The server device which operates the consensus algorithm may comprise in particular one or more server computers. In particular, the consensus algorithm may be realized as software with program instructions. The consensus value generated by the consensus algorithm may describe in particular an energy quantity transferred in the charging process. The control circuit of the motor vehicle may be in particular a controller of the motor vehicle. The charging data generated by the motor vehicle may be based in particular on vehicle-side measurement data of a vehicle-side metering circuit, detecting electric quantities corresponding to the station-side measurement data.

In the charging station and the motor vehicle exactly the same measurement values can never be measured, but still a charging process can be managed to within a predetermined tolerance. One embodiment proposes that the consensus algorithm ascertains a difference between at least one measured quantity which has been quantified by both the measurement data and the charging data. The measured quantity may be in particular an electric power and/or an electric energy and/or time and/or an electric voltage and/or electric current strength. The difference may be, e.g., the magnitude of the difference in measured values for these measurement quantities. In the event that the difference fulfills a predetermined tolerance criterion, the consensus value is calculated by means of a predetermined consensus value setting rule from the measurement, e.g., as a mean value. On the contrary, if the difference violates the tolerance criterion, i.e., the difference is greater than a given threshold value or tolerance value, an unsuccessful determination of the consensus value is reported. The tolerance criterion describes all those instances in which it is unlikely that at least one of the measurement objects will accept a consensus value which deviates from its own metered measurement data, because this would produce too large a discrepancy. The tolerance criterion may indicate in particular a tolerance range for the value of the difference. In other words, from two different measurement values for the same metered quantity (such as an energy quantity or charging time), a single consensus value will be calculated, which should be equally binding on both the motor vehicle and the charging station. Therefore, a difference due to measurement inaccuracies will be balanced out. The consensus value setting rule can provide in particular for the calculation of an average value.

One embodiment proposes that the termination procedure involves the generating of a request command by which an indication of an error in the charging process and/or faulty measurement data is put out by at least one output device. In other words, the user of the motor vehicle and/or the operator of the charging station can be informed as to the discrepancy between charging data and measurement data. A countermeasure to prevent further inconsistent data may be introduced for future charging processes. The output device may comprise a monitor screen, in particular, and/or it may generate an e-mail.

If the metering circuits of charging station and motor vehicle generate different measurement values, the charging process should be terminated as soon as possible. One embodiment proposes that the consensus value is repeatedly updated during the charging process and the termination procedure involves sending a reset command to the charging station and/or a terminate command to the motor vehicle, thereby interrupting the transfer of further energy in the charging process. In other words, the charging process is checked repeatedly in regard to the consensus value at different times during the charging process, i.e., continuously or at intervals. It will be possible to avoid greater damages or greater detriments such as might result otherwise from a continuation of the charging process. The reset command may in particular initiate the opening of a switch of the charging station. The terminate command may in particular halt a voltage converter of a charging device of the motor vehicle.

When the energy quantity received in the motor vehicle is metered for example at the electric energy storage, this metered value is systematically smaller than the corresponding metered value of the charging station during the recharging of energy, because electric losses on the conduits are not also measured. One embodiment proposes that the controller in the motor vehicle operates a loss model for the determining of the charging data, describing electric losses in a coupling device connecting the charging station to the motor vehicle and/or within a power grid of the motor vehicle. The coupling device here may comprise in particular a charging cable and/or induction coils, across which the energy is transferred. The power grid of the motor vehicle may comprise on-board grid wiring and/or a switching converter. In other words, the metering circuit in the motor vehicle need not be directly at the charging terminal (i.e., at the connection point to the coupling device), but instead it may use a metering circuit, such as may be present for example in the energy storage (i.e., the battery, for example). In order to still detect the overall energy drawn from the charging station during a recharging process, the electric losses resulting during the transfer in the motor vehicle and/or in the coupling device can be calculated by means of the loss model. Thus, the charging data are calculated with the aid of measurement data determined on the vehicle side and influenced by the electric losses and with the aid of the loss model. A systematic discrepancy or a systematic difference between the charging data of the motor vehicle and the measurement data of the charging station will be prevented, such as might result from the different metering points or measuring stations. The loss model may be in particular a mathematical and/or digital model.

The measurement data of the charging station and/or the charging data of the motor vehicle might also carry noise or contain gaps, for example, which can likewise be used to monitor the suitability of a measurement object (motor vehicle/charging station) for the system. One embodiment proposes that a data evaluation algorithm is provided in the server device before the consensus algorithm and the data evaluation algorithm is used to determine, with the aid of a predetermined quality criterion, a data quality of the measurement data (from the charging station) and the charging data (from the motor vehicle) and/or a number of predetermined charging slumps (charging interruptions) and if the quality criterion is violated then the termination procedure is initiated. In other words, the continuation procedure is only carried out if the quality criterion is fulfilled. The data evaluation algorithm may be in particular software with program instructions. The quality criterion may describe in particular a noise and/or a volatility of a measurement signal as described by the measurement data or charging data. The data quality in particular can be described by a quality or a deviation from a predetermined ideal value in regard to noise and/or volatility. The charging slumps may be in particular an interruption of the energy flow. The use quality may indicate in particular a quantification of charging delays caused by the charging slumps. In order to initiate the termination procedure indirectly from the data evaluation algorithm, a consensus value ascertained by the consensus algorithm may be afterwards labeled as invalid, for example.

If, however, the system should have a charging station with calibrated meter, the measurement quality assured by this can be utilized of course to verify or check other measurement objects (motor vehicles). One embodiment proposes that, for the special case when equipment data report for the charging station that the charging station has a calibrated meter, the consensus value is ascertained solely on the basis of the measurement data. In other words, the method can be employed for multiple different charging stations and said special case may obtain for one or more of these charging stations. In another embodiment, both the charging station uses a respective noncalibrated meter for generating the measurement data and the motor vehicle uses a respective noncalibrated meter for generating the charging data. In other words, only non-calibrated meters are used, which need not be officially calibrated once again for a design change (such as a new vehicle series). No cost intensive approvals need to be secured for the meters. If multiple charging stations are present in the system, and if a calibrated meter is present, this will again be used as a reference. The equipment data indicating this presence may be saved in particular in the server device and/or be indicated by the charging station and/or a server of its operator. The calibrated meter may be in particular an officially calibrated measurement instrument.

The evaluation of the measurement objects (in regard to the possibility of determining consensus values with them and/or obtaining unfair noisy measurement data/charging data) can be utilized for future charging processes. In one embodiment for this, the server device is used to ascertain respective evaluation data about the charging station and about the motor vehicle and the consensus algorithm is used to establish a respective portion of the station-side measurement data and the vehicle-side charging data during the determining of the consensus value by the evaluation data, wherein the evaluation data describes a data quality and/or a data availability and/or a use quality of the measurement data provided by the charging station and/or that of the charging data provided by the motor vehicle. In other words, it describes which predetermined quality features of the charging station and/or the motor vehicle are to be expected. For the planning of a charging process, a selection of a suitable charging station can be made and/or a selection criterion for motor vehicles approved for the charging station can be provided specifically for an operator of a charging station. In other words, a decision can thus be made as to which charging station and/or which motor vehicle may still participate in the system in future. The evaluation data may be saved in particular in a data storage of the server device. The portion may be calculated in particular in a weighted addition using weighting factors made dependent on the evaluation data. The data quality may describe in particular the described noise and/or the described variance or volatility. The data availability may describe in particular the measurement quantities as described by the measurement data and/or charging data. The use quality may indicate in particular a frequency or probability of a charging interruption.

In order to obtain reliable evaluation data, the data should always take account of multiple charging processes or be based on multiple charging processes. One embodiment proposes that the evaluation data are updated specifically for the motor vehicle and/or the station by means of a predetermined measurement object evaluation algorithm with each charging process for multiple charging processes on the basis of the respective measurement data and charging data of the charging process. In other words, the charging station and/or the motor vehicle is observed over the span of multiple charging processes in order to ascertain how reliable are the charging data provided by the motor vehicle and/or the measurement data provided by the charging station. The evaluation data may describe a statistical mean value, thereby forming a more reliable evaluation criterion. The measurement object evaluation algorithm may use in particular the data evaluation algorithm and/or the consensus value algorithm to determine the evaluation data in the described manner.

With the aid of the evaluation data it is possible for example to avoid using a faulty charging station for a charging process or to avoid servicing a motor vehicle with faulty metering circuit at a charging station. One embodiment proposes that a charging plan of at least one future charging process is controlled by means of the evaluation data such that only charging stations and/or motor vehicles whose respective evaluation data fulfill a predetermined acceptability criterion are approved for the at least one future charging process and/or charging stations and/or motor vehicles are prioritized according to their evaluation data. In other words, unsuitable motor vehicles whose charging data do not result in a consensus value and/or charging stations whose measurement data do not result in a consensus value are excluded from the system. Unsuitable participants can be blocked or excluded in automated manner. In particular, the charging plan can determine at least one charging station for replenishing an energy storage of the motor vehicle for an upcoming trip whose travel route has been determined. The acceptability criterion may represent in particular an acceptance restriction for participants of the system (suitable charging stations and suitable motor vehicles).

One embodiment proposes that the evaluation data for multiple charging stations are combined to form a charging column map, utilizing the charging processes of multiple motor vehicles, and used in the charging plan in order to select charging stations for future charging processes along a given route. In other words, crowd-sourced data (namely, data from multiple motor vehicles) can be used to obtain statistically substantiated evaluation data. Organized charging plans can be based on the availability and charging capability of the charging column. The charging column map may be configured in particular as a so-called heat map, indicating the values indicated in the evaluation data.

One embodiment proposes that the server device comprises multiple server computers, each of which controls charging processes independently of the other respective server computers, and the evaluation data are retrieved from a distributed ledger technology, DLT, and/or made available via the DLT to the other server computers. In other words, the evaluation data are not stored centrally, but rather the server computers exchange the evaluation data through a DLT, so that the authenticity of the evaluation data is assured by the DLT. A control process without central administration and scalable by subsequent adding of server computers can provide an operative measurement data verification. A respective server computer may be in particular a cloud computer for a computer cloud or a network computer for a virtual network. The DLT may comprise in particular a blockchain-based data storage.

One embodiment proposes that the continuation procedure involves saving the consensus value by means of a distributed ledger technology, DLT, especially a blockchain, and a) a smart contract of the DLT is initiated and/or b) an energy quantity as described by the consensus value and a corresponding time stamp of the charging process is saved in a checkbook of an energy storage of the motor vehicle and/or in a charge verification data storage. In other words, the consensus value is used, e.g., for a payment process of a smart-contract and/or to document a wear condition of the energy storage. The measurements carried out during the charging process in the charging station and/or in the motor vehicle are made available in a compact form as a consensus value. The smart-contract may be in particular an evaluation program interconnected with the DLT or contained therein, having a program sequence dependent on the consensus value. The time stamp can indicate in particular a date and/or the clock time. The checkbook may be in particular a digital data record, which can be administered for example by the maker of the energy storage. The energy storage can be in particular a high-voltage battery (high voltage is an electric voltage greater than 60 Volts, especially greater than 100 Volts).

Embodiments of the invention also provide a system for the providing of a charging infrastructure, having said server device and having multiple charging stations and multiple motor vehicles, the system being adapted to carry out a method as described herein. In other words, the motor vehicles and the charging stations may be participants in a common system in which no calibrated meters are necessary, since the charging station and the motor vehicle can mutually verify each other during each charging process. The system can be provided as a system requiring calibrated meters with low material costs or production costs.

One embodiment proposes that the server device comprises at least one server computer, which is respectively adapted to carry out the steps of the methods described herein regarding the server device. A server computer may comprise a processor device for this, which is adapted to carry out the steps regarding the server device of one embodiment of the method. The processor device for this may comprise at least one microprocessor and/or at least one microcontroller and/or at least one FPGA (Field Programmable Gate Array) and/or at least one DSP (Digital Signal Processor). Furthermore, the processor device may comprise program code, which is adapted to carry out the steps of the method when executed by the processor device. The program code may be stored in a data storage of the processor device.

The respective motor vehicle may be configured as an automobile, especially a car or truck, or as a minibus or motorcycle.

Embodiments of the invention also encompass realizations in which features of different ones of the described embodiments are combined, as long as these embodiments are not explicitly presented as alternatives.

### BRIEF DESCRIPTION OF THE SEVERAL VIEWS OF THE DRAWINGS

In the following, embodiments of the invention shall be described.

FIG. 1 illustrates a schematic representation of one embodiment of a system.

FIG. 2 illustrates a sequence diagram to illustrate one embodiment of a method.

### DETAILED DESCRIPTION

Described herein are advantageous embodiments of the invention. In the described embodiments, the described components of the embodiments each time represent individual features to be viewed independently of each other. Therefore, the disclosure also encompasses other combinations of the features of the embodiments than the ones presented. Furthermore, the described embodiments can also be supplemented by other of the already described features.

In the figures, the same reference numbers each time denote functionally identical elements.

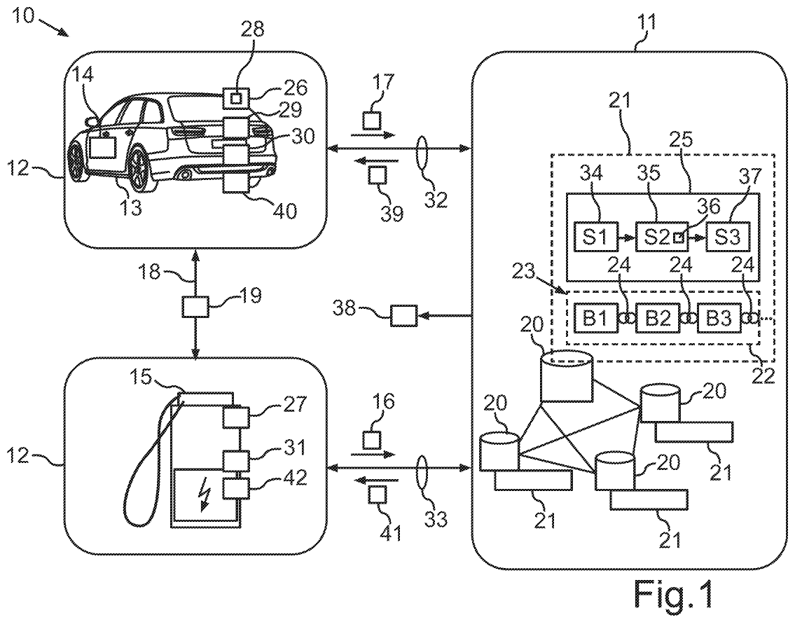

FIG. 1 shows a system 10 which may comprise a server device 11 by which a charging process verification and measurement object evaluation can be independently started, carried out, evaluated and concluded during electric charging processes. The measurement objects 12 may be designed as power source and power sink. The measurement objects 12 represented involve in particular an electrically powered motor vehicle 13 having an electric battery storage device 14 and an electric charging station 15.

The motor vehicle 13 may be a private motor vehicle or it may belong to a fleet of a corporation or a vehicle leasing party. The system 10 may encompass multiple motor vehicles 13 and/or multiple charging stations 15. The charging stations 15 constitute a charging infrastructure for the motor vehicles 13.

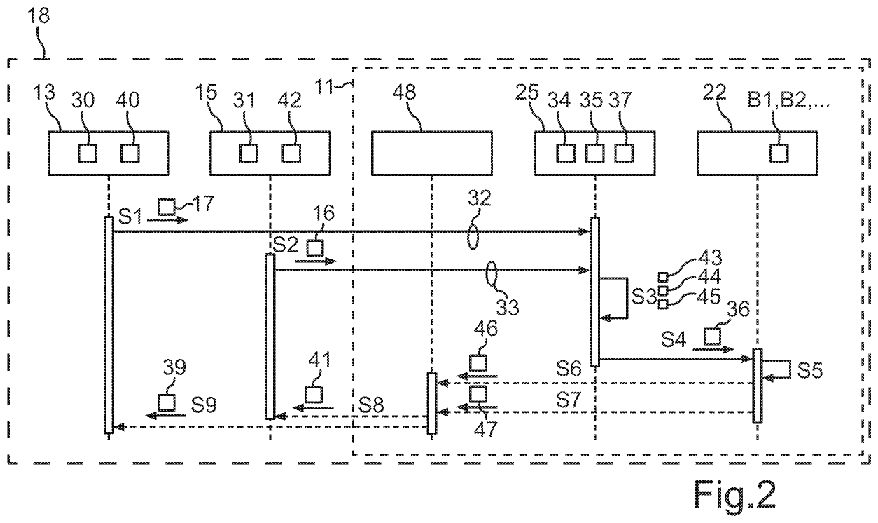

Thanks to the server device 11, measurement data 16 of a respective charging station 15 and charging data 17 of a respective motor vehicle 13 can be independently verified at low cost during a charging process 18 in which energy 19 is transferred between the motor vehicle 13 and the charging station 15, and the use quality of the charging station 15 and the motor vehicle 13 can likewise be evaluated, as shall be further described in detail in connection with FIG. 2.

The server device 11 may comprise one or more server computers 20, each of which can operate a control module 21 in order to control or dismiss respective charging processes 18 of the motor vehicle 13 or the charging station 15, taking into account the particulars of the motor vehicle 13 and its owner, as well as those of the charging station 15 and its operator. A control module 21 can be realized on the basis of program data or program code of software. Thanks to a control module 21, a storage device 22 can be operated in order to provide a respective data storage for the motor vehicles 13 and for the respective charging station 15. For example, such a storage device 22 may be formed as a distributed ledger technology 23, e.g., a blockchain made from multiple blocks B1, B2, B3 interlinked with each other for example through check sums or hash codes 24. The three blocks B1, B2, B3 represented here are only an example: it is possible to provide n blocks, where the number n may also be greater than three.

The data stored in the storage device 22 may be processed for example by a smart contract 25, whose program code can be automatically executed by the respective server computer 20. The server computers 20 can exchange the storage device 22 with each other as a data structure, so that all server computers 20 have the same data available to them. Thanks to the unalterable storing of the identities, for example by means of a public key of the respective motor vehicle 13 and the respective charging station 15 in the storage device 22 of the server device 11, these become a trusted or authenticated instance or participant of the server device 11.

The charging process verification and the measurement object evaluation begins as soon as a charging process 18 is started or concluded between a motor vehicle 13 and a charging station 15 of the system 10 and a wired or wireless physical exchange of energy 19 has taken place. The calibrated or noncalibrated measurement instruments 26, 27 of the measurement objects 12 ascertain measurement data such as voltage, current strength, and power. The charging data 17 of the motor vehicle 13 are formed from measurement data 28 of the measurement instrument 26 and from data of a loss mode 29. Losses accrue for example on the charging cable or on the power grid of the motor vehicle 13 during the charging process 18. The measurement data 16 are formed by the measurement instrument 27 of the charging station 15. Communication circuits 30, 31 relay the charging data 17 or measurement data 16 across communication channels 32, 33 to the server device 11 for one of the control modules 21. The control module 21 of the server device 11 consists of the storage device 22, which can be executed by the distributed ledger technology 23, such as a blockchain, and a smart contract 25. The smart contract 25 contains the program code, which processes the data received through algorithms. The charging process verification comprises a data evaluation algorithm 34 and a consensus algorithm 35 for automatic setting of a consensus value 36. A measurement object evaluation algorithm 37 is used to evaluate the measurement objects 12.

Once the consensus value 36 has been set, it is saved in the storage device 22. On this basis, a billing 38 can be done, for example during a quantitative energy verification.

If no consensus value 36 has been found, the charging process 18 and thus the transfer of energy 19 can be interrupted at any time by the motor vehicle 13 and the charging station 15. For this, the server device 11 sends via the communication channel 32 a control command 39 to a controller 40 of the motor vehicle 13 and/or via the communication channel 33 a reset command 41 to a clearance 42 of the charging station 15.

FIG. 2 illustrates once again the active or concluded charging process 18. The charging data 17 of the motor vehicle 13 are sent in a step S1 and the measurement data 16 of the charging station 15 are sent in a step S2 from the communication circuits 30, 31 via the communication channels 32, 33 to the smart contract 25.

In a step S3, the automated algorithms 34, 35, 37 are executed in the program code of the smart contract 25.

The data evaluation algorithm 34 carries out a data evaluation 43 of the charging data 17 and the measurement data 16. The goal is to fulfill acceptability criteria with the aid of the data quality for the consensus value setting. Acceptability criteria here may be the data availability as well as the data quality.

The consensus algorithm 35 carries out a consensus value setting 44. This compares the charging data 17 with the measurement data 16. If the difference of the data (such as voltage, current strength) is within a tolerance range, a common consensus value 36 is formed by the smart contract 25. Furthermore, either the charging data 17 or the measurement data 16 may be used as a command variable for the consensus value setting 44. This may be the case when the measurement object 12 has a suitable use quality, for example thanks to a calibrated meter or a high measurement object evaluation in the data storage of the distributed ledger technology 23. The verified consensus value 36 may be, for example, an energy quantity. The verified consensus value 36 (such as the energy quantity) may serve as the basis for a billing during the charging process 18. This verified software determination method (e.g., verified energy quantity determination) may therefore enable or replace a calibrated software determination method. If no consensus value can be formed, because the acceptability criteria are inadequate, the consensus value 36 may be labeled as invalid.

The measurement object evaluation algorithm 37 assesses in a measurement object evaluation 45 the use quality of the measurement objects 12 on the basis of the data evaluation 43 and the consensus value setting 44. Charging data differences or volatility between the measurement objects 12 or charging slumps allow statements to be made as to the use quality and, accordingly, to issue evaluations. From the evaluations, a ranking of the measurement objects is created. In the case of negative evaluations, confidence is lost for correctly measuring the charging processes and thus determining the charging data. Since the identities of the measurement objects are stored inalterably in the distributed ledger technology in the server device, a direct matching can be done between the charging data and the evaluation. The higher the number of measurement methods of a measurement object with different measurement objects, the more informative the use quality of a measurement object. The evaluation of the measurement object makes a decision as to the priority of and confidence in the measurement object. For comparison, one can mention the customer reviews of online trading platforms. There is greater confidence for many positive customer reviews. The evaluation of the charging stations making use of crowd-sourced motor vehicle data may serve as the basis for charging column maps. Organized charging plans can be distinctly improved on the basis of the availability and charging performance of the charging column. The peer-to-peer charging process verification furthermore enables saving of verified and thus trusted energy quantities including time stamp in a counterfeit-proof energy storage checkbook or obtaining a charge verification. Furthermore, the regulating of the charging performance of the motor vehicle can be demonstrated. This makes sense, for example in order to demonstrate the use of discounted or regenerative electricity.

The assessment and evaluation (i.e., the data evaluation 43 and/or the consensus value setting 44 and/or the measurement object evaluation 45) can be done each time statically (i.e., by means of given calculation formulas and/or tables) and/or statistically and/or AI-based (artificial intelligence).

In a step S4, the smart contract initiates the execution of the smart contract transaction with the consensus value and the measurement object evaluation.

In a step S5, the smart contract transaction is executed on the blockchain. In a step S6, if the consensus value is valid, billing data 46 may be optionally processed and a billing 38 can be initiated. In a step S7, if the consensus value 36 is not valid, a request command 47 can optionally be made. The request command 47 can alert the measurement objects and their owners to a malfunction during the charging or a charging data tolerance. The evaluations of the measurement objects can also be retrieved by the owner.

If a malfunction should occur during the charging process, the server device 11 in step S8 can relay the reset command 41 to the clearance 42 of the charging station 15 or in step S9 it can relay the control command 39 to the controller 40 of the motor vehicle 13. This halts the charging process, whereupon the transfer of energy 19 is interrupted. This coordination may optionally be performed through a back-end server 50.

On the whole, the examples show how a method and system for the charging process verification of an electric charging process and for the use quality assessment of a charging station or motor vehicle can be provided through a decentralized server device.

German patent application no. 10 2020 113342.1, filed May 18, 2020, to which this application claims priority, is hereby incorporated herein by reference, in its entirety.

Aspects and features of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for verification of an electric charging process, comprising:
transferring electric energy between an electrically operated motor vehicle and an electric charging station;
generating, by a metering circuit of the charging station, station-side measurement data about the charging process;
receiving, by a server device, the station-side measurement data from the charging station;
generating, by a control circuit of the motor vehicle, vehicle-side charging data about the charging process;
receiving, by the server device, the vehicle-side charging data from the motor vehicle;
operating a predetermined consensus algorithm, by the server device, in order to generate, in dependence on the measurement data and the charging data, a consensus value consistently describing the charging process for both the charging station and for the motor vehicle;
if the consensus algorithm reports a successful determination of the consensus value, then initiating and/or continuing, by the server device, a predetermined continuation procedure to continue the charging process and/or to further process the consensus value; and
if the consensus algorithm reports an unsuccessful determination of the consensus value, then initiating, by the server device, a predetermined termination procedure to terminate the charging process.

2. The method according to claim 1, wherein the consensus algorithm ascertains a difference between at least one measured quantity which has been quantified by both the measurement data and the charging data and in the event that the difference fulfills a predetermined tolerance criterion the consensus value is calculated by a predetermined consensus value setting rule from the measurement data, and if the difference violates the tolerance criterion an unsuccessful determination of the consensus value is reported.

3. The method according to claim 1, wherein the termination procedure involves generating a request command by which an indication of an error in the charging process and/or faulty measurement data is put out by at least one output device.

4. The method according to claim 1, wherein the consensus value is repeatedly updated during the charging process and the termination procedure involves sending a reset command to the charging station and/or a terminate command to the motor vehicle, thereby interrupting the transfer of energy in the charging process.

5. The method according to claim 1, wherein the controller in the motor vehicle operates a loss model for the determining of the charging data, describing electric losses in a coupling device connecting the charging station to the motor vehicle and/or within a power grid of the motor vehicle, and calculates the charging data with the aid of measurement data determined on the vehicle side and influenced by the electric losses and with the aid of the loss model.

6. The method according to claim 1, wherein a data evaluation algorithm is provided in the server device before the consensus algorithm and the data evaluation algorithm is used to determine, with the aid of a predetermined quality criterion, a data quality of the measurement data and the charging data and/or a use quality depending on charging slumps and if the quality criterion is violated the termination procedure is initiated.

7. The method according to claim 1, wherein, if the charging station has a calibrated meter, the consensus value is ascertained solely on the basis of the measurement data, and/or wherein the charging station uses a first non-calibrated meter for generating the measurement data and the motor vehicle uses a second non-calibrated meter for generating the charging data.

8. The method according to claim 1, wherein the server device is used to ascertain respective evaluation data about the charging station and about the motor vehicle and the consensus algorithm is used to establish a respective portion of the station-side measurement data and the vehicle-side charging data during the determining of the consensus value by the evaluation data, the evaluation data describing a data quality and/or a data availability and/or a use quality of the measurement data provided by the charging station and/or that of the charging data provided by the motor vehicle.

9. The method according to claim 8, wherein the evaluation data are updated specifically for the motor vehicle and/or the station by a predetermined measurement object evaluation algorithm with each charging process for multiple charging processes on the basis of the respective measurement data and charging data of the charging process.

10. The method according to claim 8, wherein a charging plan of at least one future charging process is controlled by the evaluation data such that only charging stations and/or motor vehicles whose respective evaluation data fulfill a predetermined acceptability criterion are approved for the at least one future charging process and/or charging stations and/or motor vehicles are prioritized according to their evaluation data.

11. The method according to one of claim 8, wherein the evaluation data for multiple charging stations are combined to form a charging column map, utilizing the charging processes of multiple motor vehicles, and used in the charging plan in order to select charging stations for future charging processes along a given route.

12. The method according to claim 8, wherein the server device comprises multiple server computers, each of which controls charging processes independently of the other respective server computers, and the evaluation data are retrieved from a distributed ledger technology, DLT, and/or made available via the DLT to the other server computers.

13. The method according to claim 1, wherein the continuation procedure involves saving the consensus value by a distributed ledger technology, and either:
initiating a smart contract of the DLT, or
saving an energy quantity as described by the consensus value and a corresponding time stamp of the charging process in a checkbook of an energy storage of the motor vehicle and/or in a charge verification data storage.

14. A system comprising a server device, multiple charging stations, and multiple motor vehicles, wherein the system is configured to perform a method for verification of an electric charging process, comprising:
transferring electric energy between an electrically operated motor vehicle and an electric charging station;
generating, by a metering circuit of the charging station, station-side measurement data about the charging process;
receiving, by a server device, the station-side measurement data from the charging station;
generating, by a control circuit of the motor vehicle, vehicle-side charging data about the charging process;
receiving, by the server device, the vehicle-side charging data from the motor vehicle;
operating a predetermined consensus algorithm, by the server device, in order to generate, in dependence on the measurement data and the charging data, a consensus value consistently describing the charging process for both the charging station and for the motor vehicle;
if the consensus algorithm reports a successful determination of the consensus value, then initiating and/or continuing, by the server device, a predetermined continuation procedure to continue the charging process and/or to further process the consensus value; and
if the consensus algorithm reports an unsuccessful determination of the consensus value, then initiating, by the server device, a predetermined termination procedure to terminate the charging process.

15. A server device for use in a system including multiple charging stations and multiple motor vehicles, the server device comprising at least one server computer, and configured to perform a method for verification of an electric charging process, comprising:
transferring electric energy between an electrically operated motor vehicle and an electric charging station;
generating, by a metering circuit of the charging station, station-side measurement data about the charging process;
receiving, by a server device, the station-side measurement data from the charging station;
generating, by a control circuit of the motor vehicle, vehicle-side charging data about the charging process;
receiving, by the server device, the vehicle-side charging data from the motor vehicle;
operating a predetermined consensus algorithm, by the server device, in order to generate, in dependence on the measurement data and the charging data, a consensus value consistently describing the charging process for both the charging station and for the motor vehicle;
if the consensus algorithm reports a successful determination of the consensus value, then initiating and/or continuing, by the server device, a predetermined continuation procedure to continue the charging process and/or to further process the consensus value; and
if the consensus algorithm reports an unsuccessful determination of the consensus value, then initiating, by the server device, a predetermined termination procedure to terminate the charging process.
